(19) United States
(12) Patent Application Publication
(10) Pub. No.: US 2011/0221611 A1
(43) Pub. Date: Sep. 15, 2011

(54) EMERGENCY VEHICLE ALARM SYSTEM AND METHOD

(76) Inventors: ALBERT G. LEMMONS, Franklin, TN (US); Steven B. Riley, Franklin, TN (US)

(21) Appl. No.: 13/043,140

(22) Filed: Mar. 8, 2011

Related U.S. Application Data
(60) Provisional application No. 61/282,643, filed on Mar. 11, 2010.

(51) Int. Cl. G08G 1/00

(52) U.S. Cl. 340/902

(57) ABSTRACT

The emergency vehicle alarm system and method allows a user to select an emergency vehicle alert as a telematics service in a mobile vehicle. Once the user selects the alert service, a telematics operations center determines a service fee, bills the user, and debits the user's account accordingly. The emergency vehicle alert telematics service warns a civilian vehicle of an approaching emergency vehicle. The system includes a transmitter located in the emergency vehicle that transmits a signal adapted for reception by a receiving module of a telematics system located in the civilian vehicle. When the emergency vehicle signal is received by the receiving module in the civilian vehicle, an audio and/or visual alert is generated to alert the occupants of the civilian vehicle that an emergency vehicle is nearby. The civilian vehicle's telematics system may also display relative positioning of the emergency vehicle and the civilian vehicle.

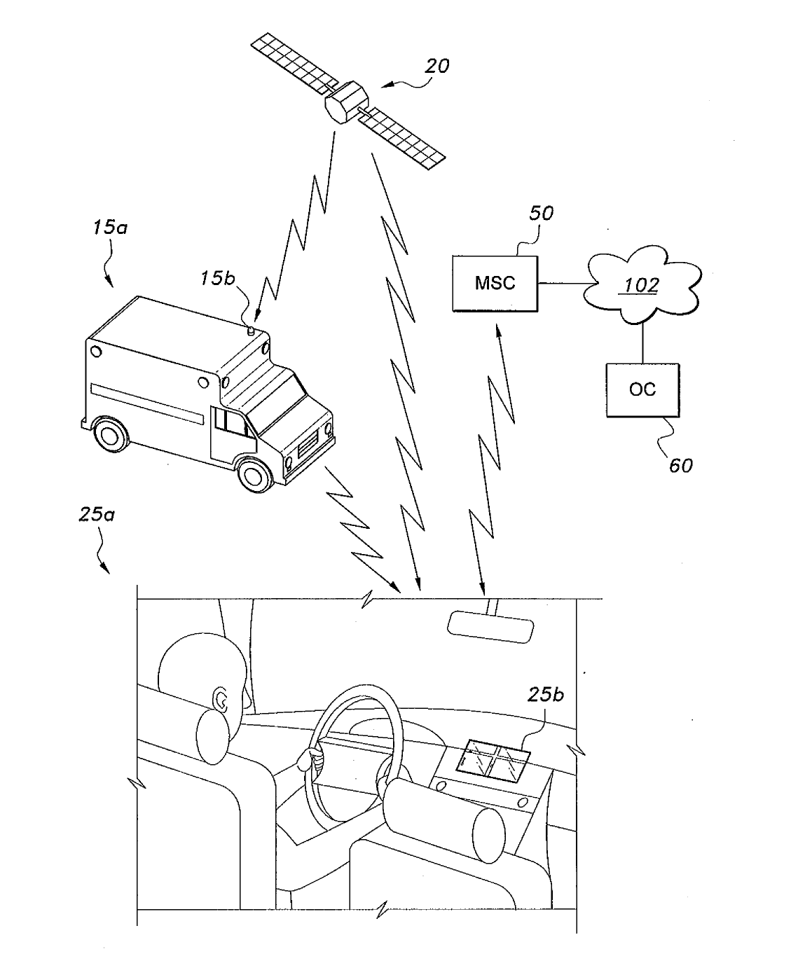

### CROSS-REFERENCE TO RELATED APPLICATION

This application claims the benefit of U.S. Provisional Patent Application Ser. No. 61/282,643, filed Mar. 11, 2010.

### BACKGROUND OF THE INVENTION

1. Field of the Invention

The present invention relates to vehicle telematics, and more specifically, to an emergency vehicle alarm system and method that generates an audio and/or visual alarm to alert the occupants of the civilian vehicle that an emergency vehicle is nearby.

2. Description of the Related Art

Oftentimes drivers are distracted by radio noises, cell phone conversations and the like, and are not very responsive to approaching emergency vehicles, sirens, lights, horns, and all. It would be desirable to enhance emergency vehicle road traffic priority requests by adding an electronic warning feature in addition to emergency flashers sirens, horns, and the like.

Thus, an emergency vehicle alarm system and method solving the aforementioned problems is desired.

### SUMMARY OF THE INVENTION

The emergency vehicle alarm system allows a user to select an emergency vehicle alert as a telematics service in a mobile vehicle. Once the user selects the alert service, a telematics operations center determines a service fee, bills the user, and debits the user's account accordingly. The emergency vehicle alert telematics service warns a civilian vehicle of an approaching emergency vehicle.

The system includes a transmitter located in the emergency vehicle that transmits a signal adapted for reception by a receiving module of a telematics system located in the civilian vehicle. When the emergency vehicle signal is received by the receiving module in the civilian vehicle, an audio and/or visual alert is generated to alert the occupants of the civilian vehicle that an emergency vehicle is nearby. The civilian vehicle's telematics system may also display relative positioning of the emergency vehicle and the civilian vehicle.

These and other features of the present invention will become readily apparent upon further review of the following specification and drawing.

### BRIEF DESCRIPTION OF THE DRAWINGS

The sole FIGURE is a block diagram of an emergency vehicle alarm system according to the present invention.

### DETAILED DESCRIPTION OF THE PREFERRED EMBODIMENT

As shown in the drawing, the emergency vehicle alarm system 10 allows a user to select an emergency vehicle alert as a telematics service in a mobile vehicle 25a. As used herein, the term “telematics” refers broadly to the combination of computer information technologies and telecommunications, and more particularly to automobile or vehicle systems that combine global positioning system (GPS) technologies with wireless telecommunication services and other wireless computer network services to provide various forms of assistance and information to the driver or occupants of the vehicle.

The telematics unit 25b is equipped to receive a signal from GPS satellite 20 to aid in determining the precise location of vehicle 25a. The telematics unit 25b of vehicle 25a communicates with a telematics operations center 60 via the Internet 102 and a mobile switching center (MSC) 50. In the system 10, the telematics unit 25b provides a user-selectable emergency vehicle alert service. When the user selects the emergency vehicle alert service from telematics unit 25b, the telematics unit 25b transmits the selection to the mobile switching center (MSC) 50, which communicates the selection information to telematics operations center 60 via the Internet 102. The telematics operations center 60 determines an emergency vehicle alert service fee, bills the user, and debits the user's account accordingly. Next, the telematics operations center 60 enables the emergency vehicle alert service by sending a signal to the telematics unit 25b via the Internet 102 and the MSC 50. Details of an exemplary telematics services provisioning method that could be used to implement portions of the system 10 are disclosed in U.S. Pat. No. 7,406,321, issued on Jul. 29, 2008, which is hereby incorporated by reference in its entirety.

The emergency vehicle 15a receives a GPS signal from the satellite 20 in order to determine precisely the location of emergency vehicle 15a. Additionally, the emergency vehicle 15a is equipped with a universal transmitter 15b that transmits a limited range signal adapted for reception by a receiving module of telematics unit 25b, or by any other commercially available telematics unit. Preferably, the receiver in the system will have the capability to accommodate reception and interpretation of signals from any frequency transmitted by an emergency vehicle. When the emergency vehicle signal is received by the receiving module of an enabled telematics unit 25b, an audio and/or visual alert is generated to alert the occupants of civilian vehicle 25a that emergency vehicle 15a is nearby. Moreover, the receiving module of enabled telematics unit 25b silences whatever program is playing on the sound system of vehicle 25a so that the driver's attention is drawn solely to the audio/visual emergency alarm generated by activation of the receiving module.

An exemplary audio alarm generated by the receiving module of telematics unit 25b is a distinctive beeping or buzzing sound clearly audible to the occupants of vehicle 25a. An exemplary visual alarm generated by the receiving module of telematics unit 25b is a flashing light clearly visible to the occupants of vehicle 25a. The alert signal transmitted by the universal transmitter 15b may also include the GPS coordinates of the emergency vehicle 15a. Using the GPS coordinates transmitted by transmitter 15b of emergency vehicle 15a and the GPS coordinates acquired by reception of a GPS signal from the satellite 20, the telematics unit 25b of the vehicle 25a may also determine and display relative positioning of the emergency vehicle 15a and the vehicle 25a. Details of an exemplary emergency vehicle approaching alerting system that could be used to implement portions of the system 10 are included in U.S. Patent Publication No. 20040036627, published on Feb. 26, 2004, which is hereby incorporated by reference in its entirety.

It is also within contemplation of the emergency vehicle alarm system 10 to provide for mandatory activation of the emergency vehicle alert service, and to bill and then debit the user upon initial subscription to basic services available on the telematics unit 25b. Additionally, the transmitter 15b of the system 10 could be installed on non-emergency vehicles, such as trains, buses, and other priority vehicles, to warn occupants of vehicle 25a of proximity to such vehicles.

It is to be understood that the present invention is not limited to the embodiment described above, but encompasses any and all embodiments within the scope of the following claims.

We claim:

1. An emergency vehicle alarm method, comprising the steps of:
providing an emergency vehicle alert as a telematics service deliverable to a mobile vehicle;
determining a service fee for the emergency vehicle alert service;
billing the user according to the service fee-determining step;
debiting the user's account according to the billing step; and
delivering the emergency vehicle alert service to the mobile vehicle, including generating an alarm wherein when an emergency vehicle is in proximity to the mobile vehicle so that the occupants of the mobile vehicle are warned that the emergency vehicle is nearby.

2. The emergency vehicle alarm method according to claim 1, further comprising the steps of:
providing a user-selectable option to initiate said emergency vehicle alert providing step; and
accepting user selection of the emergency vehicle alert service according to the provided user-selectable option.

3. An emergency vehicle alarm system, comprising:
means for providing an emergency vehicle alert as a telematics service deliverable to a mobile vehicle;
means for determining a service fee for the emergency vehicle alert service;
means for billing the user according to the service fee-determining step;
means for debiting the user's account according to the billing step; and
means for delivering the emergency vehicle alert service to the mobile vehicle, wherein when an emergency vehicle is in proximity to the mobile vehicle, an alarm is generated by the emergency vehicle alert service so that the occupants of the mobile vehicle are warned that the emergency vehicle is nearby.

4. The emergency vehicle alarm system according to claim 3, further comprising:
means for sending an emergency alert from a priority vehicle to the mobile vehicle when said priority vehicle is in proximity to the mobile vehicle;
means for receiving the emergency alert in the mobile vehicle; and
means for actuating said alarm in the mobile vehicle based on reception of the emergency alert from the priority vehicle.

5. The emergency vehicle alarm system according to claim 4, wherein said alarm in the mobile vehicle comprises a flashing light clearly visible to the occupants of the mobile vehicle.

6. The emergency vehicle alarm system according to claim 4, wherein said alarm in the mobile vehicle comprises a distinctive sound clearly audible to the occupants of the mobile vehicle.

7. The emergency vehicle alarm system according to claim 4, further comprising means for silencing a program playing on a sound system of the mobile vehicle so that the occupants' attention is drawn solely to the emergency alarm presented inside the mobile vehicle.

8. The emergency vehicle alarm system according to claim 4, further comprising means for determining and displaying to occupants of the mobile vehicle relative positioning of the priority vehicle with respect to the mobile vehicle.
